(19) United States
(12) Patent Application Publication
(10) Pub. No.: US 2002/0186920 A1
(43) Pub. Date: Dec. 12, 2002

(54) Coupler assisted tunable add/drop filter

(76) Inventors: Jean-Francois Viens, (US); Tairan Wang, (US); Pierre Villeneuve, (US); Charles Romaniuk, (US)

Correspondence Address: Samuels, Gauthier & Stevens LLP, Suite 3300, 225 Franklin Street, Boston, MA, 02110, US

(21) Appl. No.: 10/195,231

(22) Filed: Jul. 15, 2002

Related U.S. Application Data
(63) Continuation-in-part of application No. 09/698,305, filed on Oct. 27, 2000, now Pat. No. 6,424,763.
(60) Provisional application No. 60/162,177, filed on Oct. 28, 1999.

(51) Int. Cl. G02B 6/26; G02B 6/28

(52) U.S. Cl. 385/27; 385/39; 385/50; 385/24

(57) ABSTRACT

A tunable electromagnetic field frequency filter which includes a bus waveguide that carries a signal having a plurality of frequencies, including at least one desired frequency, and a receiver waveguide. A resonator-system is coupled to the bus and receiver waveguides via couplers, such as directional couplers, and transfers the desired at least one frequency from the bus waveguide to the receiver waveguide while allowing transmission of the remaining frequencies in the bus waveguide. The signal in the bus waveguide is coupled from the bus waveguide to the resonator-system by a first coupler. The first coupler splits the input signal into preferably equal parts and directs each part into the resonator-system. The resonator-system supports at least two system modes, and includes at least three reflectors (G1, G2, G3) with at least two different reflectivity spectra. Two resonators (R1, R2) are defined by the three reflectors. At least one of the reflectivity spectra is tuned such that at least two of the system modes have substantially the same frequency when the transfer occurs substantially. The desired frequency is transferred to the receiver waveguide by a second coupler. The non-desired frequencies are returned to the bus waveguide, in the forward direction, by the first coupler.

### PRIORITY INFORMATION

This application is a continuation-in-part application of Ser. No. 09/698,305 filed Oct. 27, 2000.

### BACKGROUND OF THE INVENTION

Add/drop filters play a vital role in wavelength division multiplexed (WDM) lightwave communication systems. In a tunable add/drop filter described in copending U.S. patent application Ser. No. 09/698,305, a bus waveguide and a receiver waveguide are coupled by an element comprising at least two resonators. The filter is capable of selectively adding or dropping one or more wavelengths over a wide range of wavelengths, such as the entire bandwidth of a WDM system. In one embodiment, the resonators are formed by at least three gratings. By adjusting the resonator and the reflection spectra of the gratings, the wavelength of the coupling element is tunable over a wide range of wavelengths. At least two of the grating spectra are different so that a Vernier effect can be achieved. The transfer function can be made flatter and sharper by increasing the number of resonators.

### SUMMARY OF THE INVENTION

In accordance with an exemplary embodiment of the invention, there is provided a coupler assisted (CA) tunable add/drop filter capable of selectively adding or dropping one or more wavelengths over a wide range of wavelengths. The CA tunable filter can have a large tuning range for covering the entire bandwidth of a WDM system. The filter can be tuned after fabrication and can be used for dynamic operation or static operation.

The CA tunable add/drop filter is an exemplary embodiment of the invention that includes two waveguides coupled by an element containing at least two resonators and at least one coupler. The coupling element determines the transfer properties of the add/drop filter, such as the wavelength of the transferred electromagnetic field, and is tunable over a wide range of wavelengths. The filter employs couplers to couple the resonator-system to the waveguides. One advantage of this embodiment is improved tolerance to parameter variations.

In another exemplary embodiment of the invention, there is provided a tunable electromagnetic field frequency filter having an input waveguide, which carries at least one desired frequency, and a receiver waveguide. A resonator-system, comprising at least two sub-elements, is coupled to the input and output waveguides via directional couplers and transfers at least one desired frequency from the bus waveguide to the receiver waveguide while allowing transmission of the remaining frequencies in the bus waveguide. The signal in the bus waveguide is coupled from the bus waveguide to the resonator-system by a first directional coupler. The resonator-system supports at least two system modes, and includes at least four reflectors with at least two different reflectivity spectra. At least one of the reflectivity spectra is tuned such that at least two of the system modes have substantially the same frequency when the transfer occurs substantially. The first directional coupler splits the input signal into two preferably equal parts and directs each part into the resonator-system sub-elements. The desired frequency is transferred to the receiver waveguide by a second directional coupler. The non-desired frequencies are returned to the bus waveguide, in the forward direction, by the first directional coupler.

Various types of reflectors can be used in the CA tunable filter for forming resonators, such as sampled gratings, chirped gratings, and super-structure gratings. The number of reflectors and resonators can be adjusted to modify the transfer lineshape.

Various types of couplers can also be used in the CA tunable filter, such as directional couplers, multi-mode interference couplers, and star-couplers.

The filter is tuned using a variety of physical phenomena for changing the dielectric and optical properties of the materials, as described in the parent case, including carrier injection, thermal heating, the piezo-electric effect, the acousto-optic effect and the electro-optic effect.

### BRIEF DESCRIPTION OF THE DRAWINGS

FIG. 1 is a schematic diagram of a tunable add/drop filter in accordance with the invention;

FIG. 2 is a schematic diagram of a tunable add/drop filter utilizing couplers in accordance with the invention;

FIG. 3 is a plan view of an exemplary embodiment of the invention utilizing directional couplers;

FIGS. 4A-4C are graphs of the reflectivity spectra of the three gratings shown in FIG. 3;

FIG. 5 is a plan view of another exemplary embodiment of the inventions;

FIG. 6 is a plan view of another exemplary embodiment of the invention; and

FIG. 7 is a schematic diagram of a tunable add/drop filter utilizing multi-mode couplers in accordance with the invention.

### DETAILED DESCRIPTION OF THE INVENTION

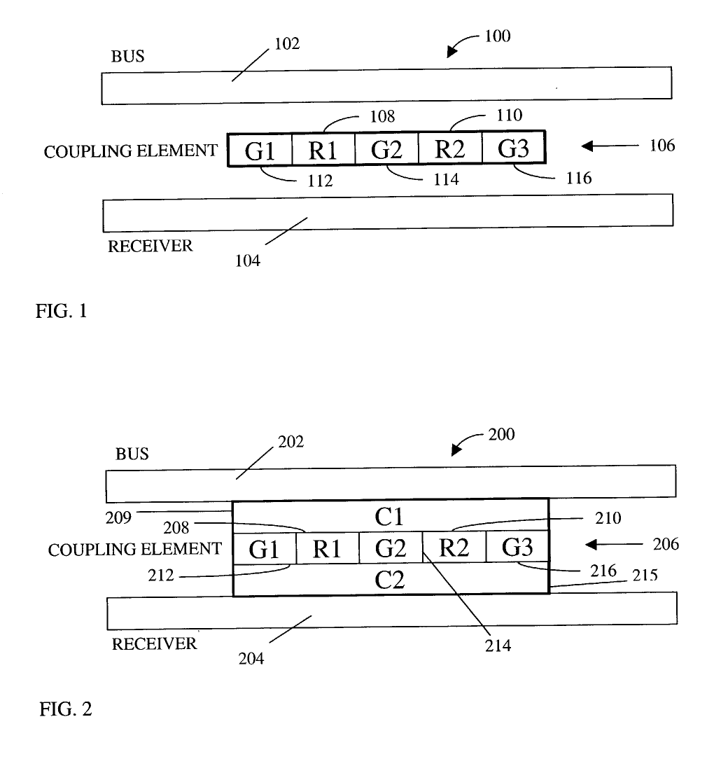

FIG. 1 is a schematic diagram of a tunable add/drop filter 100 in accordance with the invention. The filter includes an input waveguide labeled “bus” 102 and an output waveguide labeled “receiver” 104. A coupling element 106 has a resonator-system comprising two resonators, labeled R1 (108) and R2 (110). The resonators are defined using three gratings, labeled G1 (112), G2 (114), and G3 (116). The reflectivity spectra of the gratings consist of combs of reflection peaks, i.e., series of discrete frequency regions of high reflectivity separated by regions of low reflectivity. Examples of gratings include, but are not limited to, sampled gratings, chirped gratings, and super-structure gratings.

Each resonator supports at least one mode and the resonator-system supports at least two system modes. The system modes are eigenmodes of the resonator-system. Substantial transfer occurs between the bus and the receiver when the two system modes have substantially the same resonant frequency and the same overall decay rate. The wavelength of the transferred signal is selected by changing the resonant frequency of the resonators. This is accomplished by changing the reflectivity spectrum of the gratings and by adjusting the round-trip path length inside the resonators to insure resonance. The reflectivity and the round-trip path length can be adjusted, for example, using a variety of physical phenomena such as carrier injection, thermal heating, the piezo-electric effect, photo-ionization of DX centers, the acousto-optic effect, or the electro-optic effect.

In accordance with the invention, alternative geometries of this tunable add/drop filter using couplers in the coupling element to couple the resonator-system to the waveguides are provided. FIG. 2 is a schematic block diagram of a coupler assisted (CA) tunable add/drop filter 200 in accordance with the invention. The CA tunable add/drop filter 200 includes a bus waveguide 202 that is coupled to a receiver waveguide 204 by a coupling element 206. The coupling element comprises a resonator-system, a first coupler, labeled C1 (209), for coupling the resonator-system to the bus waveguide 202, and a second coupler, labeled C2 (215), for coupling the resonator-system to the receiver waveguide 204. The resonator-system comprises two resonators, R1 (208) and R2 (210), defined using three gratings, G1 (212), G2 (214), and G3 (216). Substantial transfer occurs between the bus and the receiver waveguides when the resonator-system modes have substantially the same resonant frequency and the same overall decay rate. Coupling between the various resonator modes is controlled by using the couplers 209, 215.

The wavelength of the transferred signal is selected by changing the reflectivity spectrum of the gratings and by adjusting the round-trip path length inside the resonators to insure resonance. The reflectivity and the round-trip path length can be adjusted, for example, using a variety of physical phenomena for changing optical properties, such as carrier injection, thermal heating, piezo-electric, photo-ionization of DX centers, the acousto-optic effect, or the electro-optic effect.

The gratings preferably have reflection peaks with different frequency spacing. Since each grating has a different frequency spacing, it is possible to align one reflection peak from each grating so that all three gratings have a reflection at the same frequency, while keeping all other reflection peaks misaligned.

By frequency shifting at least one reflection spectra, tuning can be accomplished. The resonators become resonant at different frequencies by aligning different reflection peaks. This effect, called the Vernier effect, can be used to tune the filter over a wide frequency range while using only small frequency shifts.

The configuration of the CA embodiment is mathematically equivalent to a side-coupled embodiment described in the parent case; there is a one-to-one mapping between them. Moreover, in both filter configurations, the signal in the receiver waveguide can be made to propagate in either the forward or backward direction by changing the relative phase of the modes in the resonator-system.

The use of couplers has the highly-desired effect of reducing the sensitivity of the filter to parameter variations. Hence, an advantage of the CA configuration is that it is more tolerant to parameter variations that occur during fabrication. As a result, back reflection in both the bus and receiver waveguides is minimized for a large range of parameter variations.

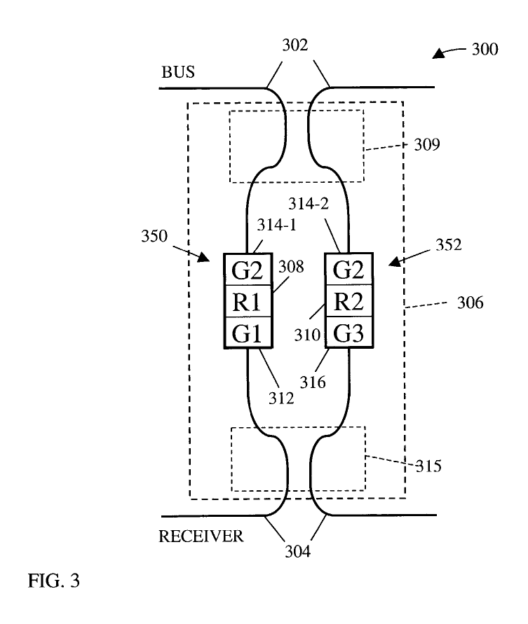

In an exemplary embodiment of the invention as shown in FIG. 3, a CA tunable add/drop filter 300 includes a coupling element 306 having a resonator-system coupled to bus 302 and receiver 304 waveguides by two directional couplers 309, 315. The resonator-system comprises two resonators, R1 (308) and R2 (310) and the resonators are defined using four gratings labeled G1 (312), G2 (314-1 and 314-2), and G3 (316). Waveguide heaters (not shown) are located above the resonators and gratings for changing the optical properties of the materials.

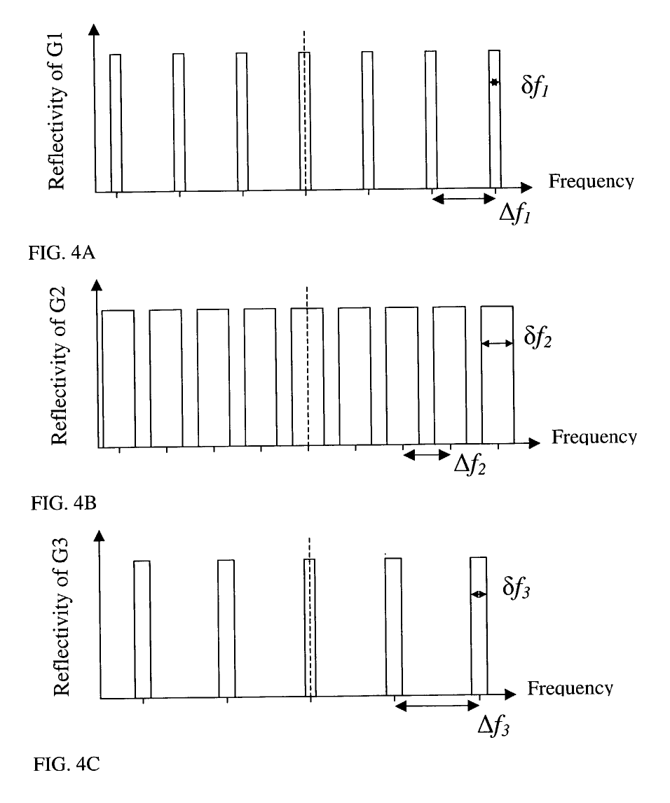

In the exemplary embodiment shown in FIG. 3, the filter is operated by shifting two reflectivity spectra. The reflectivity spectra of G2 are preferably the same and are aligned with the frequencies of interest, such as the standard International Telecommunication Union (ITU) grid. Tuning is preferably achieved by shifting the reflectivity spectra of G1 and G3. Tuning can also be achieved by shifting the reflectivity spectra of G2. The comb-like reflectivity spectra of the gratings are shown schematically in the graphs of FIG. 4. Each spectrum consists of a series of reflection peaks separated by a different frequency spacing Δfᵢ (i=1, 2, or 3). Since each grating has a different frequency spacing, one reflection peak from each grating can be aligned, so that all three gratings have a reflection peak aligned at the same frequency, while keeping all other reflection peaks misaligned. The round-trip resonant condition in each resonator can also be tuned so that they are aligned at the same frequency as the gratings. Substantial transfer occurs between the bus and receiver when the reflectivity peaks are aligned and the two system modes have substantially the same resonant frequency and the same overall decay rate.

In this embodiment, the resonator-system comprises two sub-elements 350, 352 each including at least one resonator. The directional couplers 309, 315 split the incoming bus signal into the two resonator-system sub-elements 350, 352, and also recombine the signals from the two sub-elements 350, 352 either into the bus or receiver waveguide. The recombined signals are directed preferably in the forward direction. A desired frequency propagates into the receiver waveguide 304 while non-desired frequencies propagate along the bus waveguide 302. The directional couplers 309, 315 are preferably 50/50 splitters or combiners so that the bus signal is equally split between the two resonator-system sub-elements 350, 352.

In this embodiment, the bus signal is split by the first directional coupler 309 and directed to the first gratings, G2, in the sub-elements 350, 352. Non-resonant channel frequencies are reflected by G2 and directed back onto the bus 302 in the forward direction. The resonant channel frequencies are transmitted through the resonator-system and recombined by the second directional coupler 315 onto the receiver waveguide 304 in the forward direction. To achieve substantial transfer between the bus and the receiver, the reflectivity spectra of G1 and G3 are aligned to the same peak with G2. This results in the two system modes of the resonators having substantially the same resonant frequency and the same overall decay rate.

From symmetry, a resonant channel frequency in the backward direction on the bus waveguide 302 is transferred to the receiver waveguide 304. Also, a resonant channel frequency on the receiver waveguide 304 is transferred to the bus waveguide 302.

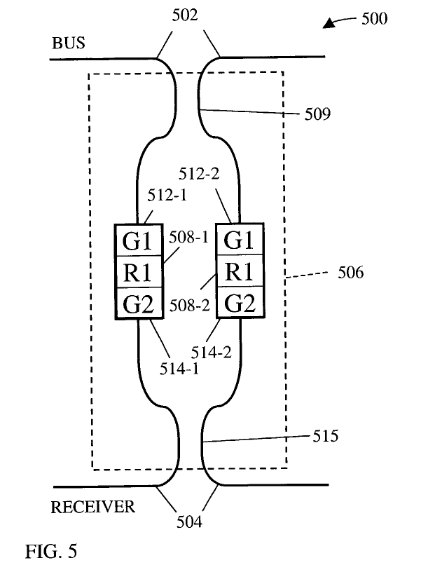

In another preferred embodiment, similar to the previous embodiment, a CA tunable add/drop filter 500 uses four gratings labeled G1 (512-1, 512-2) and G2 (514-1, 514-2) to form two resonators labeled R1 (508-1, 508-2), as shown in FIG. 5. The filter includes a coupling element 506 having a resonator-system coupled to a bus waveguide 502 by a first directional coupler 509 and to a receiver waveguide 504 by a second directional coupler 515. Waveguide heaters (not shown) are located above the resonators and gratings for changing the optical properties of the materials.

In this embodiment, G1 and G2 have different reflectivity spectra and the filter 500 is operated by shifting the reflectivity spectra of G2. The reflectivity spectra of G1 are aligned with the channel frequencies of interest. Tuning can also be achieved by shifting the reflectivity spectra of G1.

Since each grating has a different frequency spacing, one reflection peak from each grating is aligned, while keeping all other reflection peaks misaligned. The round-trip resonant condition in each resonator is also tuned so that they are aligned at the same frequency as the gratings.

In another embodiment, multiple reflection peaks from each reflector are aligned so that all the reflectors have multiple reflection peaks aligned at the same frequencies. In this embodiment, multiple channels are simultaneously transferred between the waveguides. For example, by aligning reflection peaks such that the reflection peaks align with a frequency spacing of df, every Nth channel is transferred.

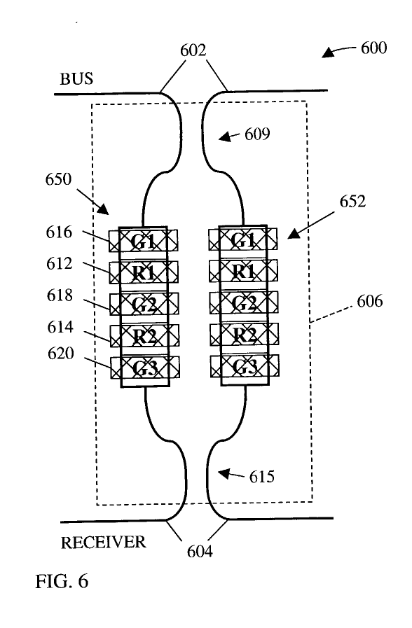

FIG. 6 is a plan view of another exemplary embodiment of a CA tunable add/drop filter 600. The filter includes a bus waveguide 602, a receiver waveguide 604, and a coupling element 606 having a resonator-system comprising four resonators, labeled R1, and R2, in two sub-elements 650, 652. The coupling element 606 also includes two directional couplers 609, 615 for coupling the resonator-system to the bus and receiver waveguides. The resonators are defined using six gratings labeled G1, G2, and G3. The resonator-system sub-elements 650, 652 are the same in this embodiment in order to simplify design. However, the resonator-system sub-elements 650, 652 do not need to be the same.

In this embodiment, electrodes 612, 614, 616, 618, 620, indicated by cross-hatched regions, are located over the gratings and the resonators for changing the optical properties of the materials. The use of four resonators has the advantage of generating “flat top” and “sharp sidewall” response characteristics. Additional resonators pairs could be added to this embodiment to further modify the transfer lineshape.

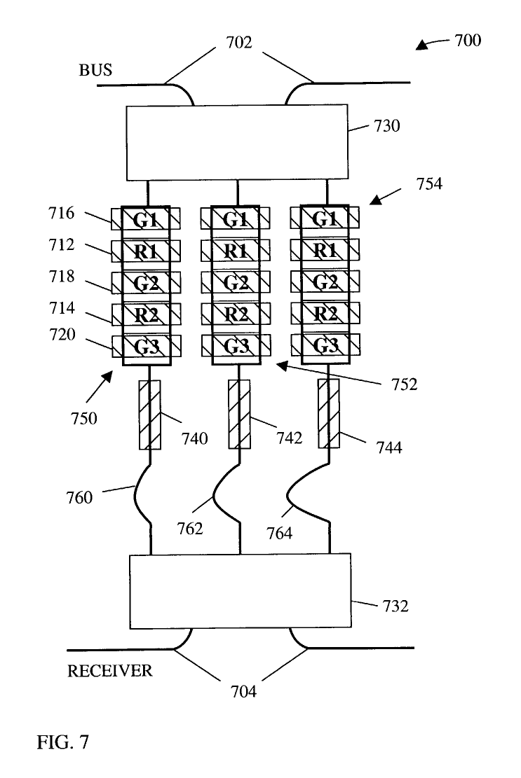

Other couplers, such as multi-mode couplers, can also be used in the coupling element for coupling the resonator system to input and output waveguides. FIG. 7 is a plan view of another exemplary embodiment of a CA tunable add/drop filter 700 that uses multi-mode couplers. The filter 700 includes a resonator-system comprising six resonators, labeled R1 and R2, in three sub-elements 750, 752, 754. Although this embodiment uses three sub-elements, two or more sub-elements can be used. The resonator-system is coupled to a bus waveguide 702 and a receiver waveguide 704 by multi-mode couplers 730, 732, such as multi-mode interference couplers or diffractive star couplers. The multi-mode couplers 730, 732, which are preferably the same, split the incoming bus signal into the resonator-system sub-elements 750, 752, 754, and also recombine the signals from the sub-elements either into the bus or receiver waveguide. The recombined signals are preferably directed in the forward direction.

The resonators are defined using nine gratings labeled G1, G2, and G3. The resonator-system sub-elements 750, 752, 754 are preferably the same in this embodiment. In this embodiment, heaters 712, 714, 716, 718, 720, 740, 742, 744, indicated by diagonal shaded regions, are located over the gratings, the resonators, and the waveguides for changing the optical properties of the materials.

The first multi-mode coupler 730 splits the bus signal into the sub-elements 750, 752, 754. The non-resonant frequencies are reflected by G1 and directed back onto the bus in the forward direction. The resonant frequencies are transmitted through the resonator system and are recombined by the second multi-mode coupler 732 onto the receiver waveguide 704, preferably in the forward direction.

In order to control the coupling of the signals to and from the receiver waveguide 704, the phase of the signal in the waveguides is adjusted, such as by using the heaters 740, 742, 744, as shown in FIG. 7. The phase is also adjusted using waveguide segments 760, 762, 764, in order to obtain a phased-array and produce a coupler 732 that operates using the principle of constructive and destructive interference and is frequency dependent. As the add/drop filter 700 is tuned, the angle of the signal in the coupler 712 is adjusted, by controlling the phase of the signal, so that the desired frequency is coupled to the receiver waveguide 704 and non-desired frequencies are not coupled to the receiver waveguide 704. The phased-array also provides higher diffraction orders in the coupler, thereby improving signal coupling. An advantage over the parent case is reduced coupling of undesired frequencies to the receiver waveguide, thereby reducing cross-talk at the receiver waveguide 704.

The number of bus and receiver waveguides in this embodiment can be increased and configured so that a desired frequency, or frequencies, can be directed to a desired waveguide, such as by tuning the filter or by controlling the phase of the signals.

Although the embodiments described above have been shown with two or three sub-elements, the resonator-system in the coupling element of the CA tunable add/drop filter has preferably two or more resonator sub-elements. The number of resonator sub-elements can be extended to any desired value. Each subsequent sub-element can further be subdivided in a hierarchical fashion.

The CA tunable add/drop filter presented in this disclosure can be fabricated in any of a large number of material systems such as III-V or II-VI compound semiconductors, or Si-based material systems.

Although the present invention has been shown and described with respect to several preferred embodiments thereof, various changes, omissions and additions to the form and detail thereof, may be made therein, without departing from the spirit and scope of the invention.

What is claimed is:

1. A tunable electromagnetic field frequency filter comprising:
an input waveguide that carries a signal having at least one frequency including at least one desired frequency;
an output waveguide; and
a resonator-system coupled to said input and output waveguides by at least one coupler, said resonator-system transfers at least one desired frequency to said output waveguide, said resonator-system supporting at least two system modes, said resonator-system comprising at least four reflectors with at least two different reflectivity spectra, and at least one of said reflectivity spectra being tuned such that at least two of said system modes have substantially the same frequency when said transfer occurs substantially.

2. The filter of claim 1, wherein said at least one coupler comprises a directional coupler

3. The filter of claim 1, wherein said reflectors comprise gratings.

4. The filter of claim 3, wherein said gratings have sampled periodicity, super-structure periodicity, modulated periodicity, or chirped periodicity.

5. The filter of claim 1, wherein at least one reflectivity spectrum is changed by changing the optical properties of the reflector.

6. The filter of claim 5, wherein the refractive index of at least one reflector is changed.

7. The filter of claim 5, wherein the optical properties are changed using electrical, optical, mechanical, acoustic, or thermal means.

8. The filter of claim 5, wherein the optical properties are changed by injecting carriers or by applying an electric field.

9. The filter of claim 6, wherein the refractive index is changed by changing temperature.

10. The filter of claim 1, wherein at least one system mode is changed by changing the optical properties of at least one resonator.

11. The filter of claim 1, wherein each of said input and output waveguides is physically connected to said resonator-system by at least one waveguide.

12. The filter of claim 1, wherein said resonator-system is coupled by two couplers.

13. The filter of claim 1, wherein said reflectivity spectra comprise regions of high reflectivity.

14. The filter of claim 13, wherein said regions of high reflectivity are aligned in close proximity to said desired frequency when said transfer occurs substantially.

15. The filter of claim 13, wherein the optical properties of the resonators are tuned such that the frequencies of said system modes lie within said regions of high reflectivity when said transfer occurs substantially.

16. The filter of claim 1, wherein said resonator-system comprises at least two sub-elements.

17. The filter of claim 1, wherein at least two reflectors have the same reflectivity spectrum.

18. The filter of claim 1, wherein said at least one coupler comprises a multi-mode interference coupler.

19. The filter of claim 1, wherein said at least one coupler comprises a star-coupler.

20. The filter of claim 1, wherein said coupler further comprises a phased-array.

21. A method of selectively transferring electromagnetic fields between two waveguides comprising:
providing an input waveguide which carries a signal having at least one frequency including at least one desired frequency, and an output waveguide; and
coupling a resonator-system to said input and output waveguides by at least one coupler, said resonator-system supporting at least two system modes, said resonator-system comprising at least four reflectors with at least two different reflectivity spectra, at least one of said reflectivity spectra being tuned such that at least two of said system modes have substantially the same frequency when said transfer occurs substantially.

22. A method of selectively transferring electromagnetic fields between two waveguides comprising:
providing an input waveguide which carries a signal having at least one frequency including at least one desired frequency, and an output waveguide; and
coupling a resonator-system to said input and output waveguides by at least one directional coupler, said resonator-system supporting at least two system modes, said resonator-system comprising at least four reflectors with at least two different reflectivity spectra, at least one of said reflectivity spectra being tuned such that at least two of said system modes have substantially the same frequency when said transfer occurs substantially.
